(19) United States
(12) Patent Application Publication
(10) Pub. No.: US 2018/0066329 A1
(43) Pub. Date: Mar. 8, 2018

(54) STIRRERS FOR CRYSTALLIZING EVAPORATOR

(71) Applicant: SÜDZUCKER AG, Mannheim (DE)

(72) Inventor: Jochen ARNOLD, Worms (DE)

(73) Assignee: SÜDZUCKER AG, Mannheim (DE)

(21) Appl. No.: 15/558,862

(22) PCT Filed: Mar. 15, 2016
(86) PCT No.: PCT/EP2016/055520

§ 371 Date: Sep. 15, 2017

(30) Foreign Application Priority Data
Mar. 19, 2015 (DE) 10 2015 205 034.3

(51) Int. Cl. C13K 1/10; B01F 7/00; C13B 30/02; B01D 9/00; B01F 15/06

(52) U.S. Cl. CPC C13K 1/10; B01F 7/0065; C13B 30/028; B01F 2015/062; B01D 9/005; B01F 15/066; B01D 9/0031

(57) ABSTRACT

A stirrer for a crystallizing evaporator such a crystallizing evaporator for crystallizing sucrose from concentrated beet juice. The stirrer includes at least one active flow-conducting means selected from a group consisting of a plurality of flow-conducting propellers arranged along a shaft of the stirrer and a screw running along the shaft.

### CROSS REFERENCE TO RELATED APPLICATIONS

This application is a 371 U.S. National Stage of International Application No. PCT/EP2016/055520, filed Mar. 15, 2016, which claims the benefit of and priority to German Patent Application No. 10 2015 205 034.3, filed Mar. 19, 2015. The disclosures of the above applications are incorporated herein by reference.

### FILED

This invention relates to improved agitators suitable for vacuum pan type crystallizers, especially for the crystallization of sucrose from sugar beet thick juice. The stirrers have one or more additional active flow-conducting means.

### BACKGROUND

Vacuum pans or evaporating crystallizers are used for obtaining crystals from solutions or suspensions from which the solvent, in particular water is withdrawn. The crystallization of the crystallizable substances contained in the solution or suspension is effected by the reduction of solvent. To expel the solvent, heat is supplied to the solution or suspension in the vessel of the pan or crystallizer by means of heat exchangers, so that the solvent evaporates. The solvent is withdrawn in the so-called vapor space at the upper portion of the pan or vessel as a volatile vapor or mist.

Known systems for, in particular discontinuous, evaporation crystallization include a vessel (tank) which is usually arranged vertically. A heating element or heat exchanger is arranged on the lower, bottom-side end thereof. The heat exchanger heats up the solution or suspension introduced into the vessel. The solution is also referred to as a syrup, the crystal-containing suspension is referred to as magma.

In this context, the prior art is an agitator device consisting of a drive, a stirrer shaft and a stirrer, which mixes the solution or suspension and performs essentially two functions: the solution or suspension is pumped through the heat exchanger (heating chamber) to ensure good heating and efficient expelling of the solvent gas throughout the fill, and the suspension is dispersed to achieve as uniform and efficient crystallization as possible and in particular to prevent the formation of undesired crystal aggregates. The stirrer is usually located in the so-called “dispersing zone”, in the lower section of the vessel, particularly within a guide tube or a central tube. There, by rotation of the stirrer, a primary mixing zone is formed and a downward flow is generated to ultimately assist the movement of the medium through the heating chamber(s), which is driven by convection and steam bubble formation. Thereby, it is advantageous if, in the vessel, the medium, i.e., the solution or suspension, is formed into a flow which is as circular as possible, and in particular, all the medium is passed repeatedly through the heating chamber of the reactor.

Crystallizers of this type have long been known. However, it has been found in current studies that the establishing circulating flow of the medium, i.e. the solution or suspension, in particular the magma, in the different phases of the process of evaporation crystallization in the vessel is to be improved. In particular at high fill levels, in the vessel, particularly also in the region of the stirrer shaft, turbulences may occur, which disturb or, in extreme cases, prevent the desired circular net flow, characterized by an ascending of the medium in the wall zone of the vessel and by a descent of the medium in the central region in the region of the stirrer shaft. As a result, the efficiency of the evaporation crystallization is reduced. In particular the dispersion or overall mixing of the medium in the stirred reactor, i.e. in particular a crystal suspension (magma), an evaporation crystallizer, is to be improved.

In addition, in stirred reactors of that type, and in particular in vacuum pans, there is the problem that the stirrer is guided in a so-called central tube, in order to make possible or improve the flow-conducting effect or pumping action of the stirrer. A central tube generally encloses the stirrer completely and comprises a lower opening, whereby the pumped medium emerges and an upper opening, wherein the medium enters the central tube. In order to enable the pumping action, the fill level of the medium, i.e. of the solution or suspension, must always lie above the upper opening of the central tube in the vessel of the vacuum pan, in fact to a sufficiently large extent to ensure that a sufficiently large quantity of solution or suspension can flow into the top opening of said central tube to allow the desired circular flow. It is disadvantageous in this case that the vacuum pan must always have a corresponding degree of filling in order to establish and maintain the desired circular or toroidal flow. However, particularly in discontinuous operation, the degree of filling of the vessel fluctuates. If this falls below the level of the upper opening of the central tube, such known stirrers with a central tube will be without function and the circular flow will break off.

### SUMMARY

The invention is based on the problem of overcoming these disadvantages of known stirred reactors and in particular of vacuum pan crystallizers and, above all, to effect an improved mixing and dispersing of the medium in the reactor vessel, in particular in discontinuous evaporation crystallization, with little energy input,

The invention solves the technical problem by means of a novel stirrer for a stirred reactor and, in particular, for a crystallizer or vacuum pan, wherein at least one additional active flow-guide means is provided on or in the immediate vicinity of the shaft of the stirrer Suspension in the reactor vessel, particularly directly in the vicinity of the shaft, downwards, that is to say towards the main propeller of the stirrer.

The invention accordingly provides a stirrer according to claim 1, which is suitable for circulating medium, i.e. solution or suspension, in this vessel. The stirrer has a shaft and at least one main propeller connected to the shaft for circulating the medium. The main propeller is arranged in a primary mixing zone of the vessel. According to the invention, the stirrer is characterized in that at least one further mechanical means for the active flow conduction of the medium, i.e. of the solution or suspension, is present on or directly in the direction of its shaft and in particular upstream of the main propeller (with respect to the mean flow direction of the circulating medium),

Preferably, the at least one means is arranged immediately adjacent to the primary mixing zone.

Preferably, a plurality of such means are arranged along the shaft, namely to one another, preferably regularly, at a distance.

The means is preferably arranged directly on the shaft itself. Alternatively, it is preferably arranged directly adjacent to the shaft and in this case has, in particular, a rotational axis that is essentially parallel to the shaft.

The stirrer comprises a rotatable shaft which is arranged substantially in the longitudinal direction within the reactor vessel, that is to say generally perpendicular, and comprises a propeller, i.e. a blade stirrer, which is mechanically fixed connected thereto. The propeller is located in the dispersion zone and is driven by the shaft. It is intended to effect a circular, in particular toroidal, circular flow of this medium in the vessel. In the context of an application in crystallization solution (syrup) and the viscous crystal-containing suspension (magma), that is later formed in the course of a crystallization process, in the central region of the vessel, i.e. in the area of the stirrer shaft, are sinking essentially downwards by gravity to the primary mixing zone of the pumping main propeller. The medium is collected there by the propeller and is subsequently pumped through the heating chamber (heat exchanger) mostly arranged in the wall area of the vessel.

The invention therefore provides the arrangement of active flow-conducting means, i.e. several small stirrer elements, on the stirrer, in particular at least directly above the main propeller, i.e. blade stirrer, that is to say in the upper region along the propeller shaft, which are in particular mechanically connected to the stirrer shaft. Thereby, it can be advantageously achieved that the downward movement of the solution or suspension along the stirrer shaft is significantly assisted in order to supply it in the vicinity of the shaft onto the main propeller. According to the invention, otherwise undesirable diffuse transverse flows occurring in the region above the heating chamber are thereby avoided. In particular, the effect of the stirrer can thus be expanded to the entire volume of the cooking pan in the final phases of evaporation crystallization, i.e. in the last cooking phases.

Advantageously, this type of active flow-conducting means according to the invention makes it possible to dispense with a flow-guiding central pipe which is known per se on the stirrer. The technical teaching according to the invention is therefore particularly advantageous for the application in discontinuous evaporation crystallization since the effect of the stirrer is improved irrespective of the filling level of the vessel.

The stirrer thus fulfills two tasks in particular: (1) the efficient dispersion of a crystal suspension (magma) and (2) its efficient mixing in the process of evaporation crystallization. In this application of the stirred reactor as a discontinuously operated cooker, these two tasks are of different significance over the course of the cooking process: The dispersion is of particular importance in the first cooking section, especially with crystal sizes below 100 μm. The main focus here is to distribute the seed medium, which is introduced into the solution (syrup) to initiate crystallization, and to avoid aggregate formation of the still small crystals. Important in this respect are, in particular, the mechanical shearing action and a large specific power input into the crystal suspension. The intermixing is of particular importance in the phases of the so-called boiling-up and boiling-off of the crystal suspension. The optimization of the heat transfer from the heating elements into the suspension is achieved here. This is particularly important when using broiling vapors of low energy. The efficient mixing avoids local imbalances in the composition of the magma; these are in particular, differences in concentration, temperature differences or differences in crystal distribution.

In one embodiment of the invention, the at least one active flow-conducting means is itself designed in the form of an impeller or propeller of the blade stirrer. However, this is dimensioned substantially smaller than the, preferably single, main propeller. According to the invention, the active flow guidance of the medium, i.e. of the solution or suspension, is directly confined to the region around the shaft of the main propeller, that is, particularly to the primary mixing zone. Surprisingly, without wishing to be bound to the theory, a highly efficient improvement in the overall effect of the stirrer can be achieved by the active flow line in the immediate region around the shaft of the stirrer, which in particular is also independent of the filling level of the vessel.

According to the invention, the active flow-conducting means is designed in the form of a propeller, the diameter of which is preferably less than 50% of the diameter of the main propeller. The diameter of this flow-conducting means in the form of an impeller is preferably one tenth (10%) to one half (50%), preferably from 15% to 30% of the diameter of the main propeller or less.

Preferably, the angle of incidence of the active flow-conducting means according to the invention designed as a propeller is at most 45° to the horizontal (perpendicular to the axis of rotation), but preferably from 10 to 30° to the horizontal. According to the invention, the number of vanes is preferably at least two, but preferably from four to six vanes.

In an alternative or additional embodiment of the invention, the at least one flow-conducting means is designed in the form of a single-pass or multiple-pass screw conveyor (auger screw) and is preferably dimensioned such that the flow-conducting effect of this screw is also limited to the immediate vicinity of the shaft of the main propeller, i.e. in particular to the primary mixing zone.

The diameter of the screw is preferably from at least 5% to a maximum of 50% of the diameter of the main propeller, preferably from 15 to 30% of the diameter. The angle of incidence of the helix is preferably at most 45° to the horizontal (perpendicular to the axis of rotation), but preferably from 10° to 30°.

In an alternative embodiment of the invention, the diameter of the active flow conduit is 50% to 80% of the diameter of the main propeller.

According to the invention it is thus generally provided that, irrespective of the specific configuration of the flow-conducting means on the shaft, the active flow-conducting means is restricted to the immediate environment around the shaft of the stirrer. According to the invention, a further large propeller on the shaft, which is similarly dimensioned as the main propeller, is therefore excluded as said additional active flow-conducting means of the stirrer.

According to the invention, the active flow-conducting means is designed in such a way that the flow conduit of the solution or suspension, in which they are immersed, follows the primary net stream following the circular flow of the medium following the main propeller. For this purpose, the means for the active flow line is located upstream of the shaft and preferably in the immediate vicinity of the main propeller, that is to say particularly close to the primary mixing zone, in order to effect this. The flow-conducting effect of the active means according to the invention on the medium overlaps with the mixing zone of the main propeller. The medium directed towards the main propeller in the direction of flow is thus virtually transferred to the primary mixing zone.

Preferably, the distance of an active flow-conducting means designed as a propeller to the main propeller is at most about 1.5 times the diameter of the active flow-line means and preferably corresponds at most exactly to the diameter of the active flow-conducting means. If, in the alternative embodiment, the active flow-conducting means according to the invention is configured as a single or multi-pass screw, the distance from the beginning of the screw on the stirrer shaft to the main propeller is at most about the diameter of the screw, but the distance is preferably only about 10% of the diameter, Particularly preferably, the screw starts directly on the main propeller.

Preferably several, i.e. at least two or three of said flow-conducting means are formed on and around the stirrer shaft and are driven by the stirrer shaft. These are spaced apart from one another along the shaft, preferably at equal distance. In this case, it is provided that, depending on the filling level in the vessel, more or less of the flow conduction means arranged on the stirrer shaft engages the solution or suspension in order to effect active flow conduction. Flow-conducting means, which are located above the instant level of the solution or suspension in the vessel, i.e. within the vapor chamber, run empty. Only those that immerse into the solution or suspension effect the active flow conduction.

It is particularly provided that the active flow-conducting means are spaced from one another on the stirrer shaft in such a way that their respective areas of action on the flow of the suspension overlap. The medium directed along the flow direction towards the main propeller, i.e. along the stirrer shaft, is thus transferred practically from one active flow-conducting means to the next, like in a bucket brigade, and finally into the primary mixing zone of the main propeller. It is preferably provided to arrange the active flow-guiding means at a distance which is at most approximately 1.5 times the diameter thereof, the spacing of the active flow-conducting means preferably being equal to its diameter or the distance being less.

In a preferred embodiment, the means are regularly spaced from each other. Alternatively, the distances of the means are increased with increasing distance from the main propeller or the primary mixing zone. Advantageously, the flow conduction to the main propeller can thus be improved. Without wishing to be bound by theory, the volume flow on the additional active flow-conducting means according to the invention can thus be reduced as the distance from the main propeller or the primary mixing zone increases and can be adapted to the local compensating flows, which is in support of the formation of the desired toroidal circular flow in the reactor vessel.

Alternatively or additionally, the active flow guide can be adapted with increasing distance from the main propeller, or from the primary mixing zone, by virtue of the fact that the mechanical pumping action of the means itself, in particular the angle of attack of the blades of the propellers or of the screw flights and/or the diameter of the means, individually as a function of its distance from the main propeller or mixing zone. This adaptation of the active flow guide with increasing distance from the main propeller preferably concerns a reduction in the pumping action at a distance from the main propeller. In an alternative embodiment, it is provided, depending on the geometric configuration or orientation of the vessel and the locally prevailing specific flow conditions, that the pumping action of the respective means is increased at a distance from the main propeller. A variant is preferred in which the individual pumping power of the individual active flow-conducting means decreases with a distance from the main propeller, but again increases with the “upper” means adjacent to the vapor chamber. It is particularly provided that the profile of the pumping action of the active flow-conducting means arranged along the stirrer shaft is specifically adapted to the design or orientation of the vessel and/or to the mode of operation, in particular to the discontinuous operation, and/or the rheological characteristics of the medium or magma. This adaptation takes place during the planning and production of the stirrer shaft. Alternatively or additionally, means are provided for adapting the pumping action of the active flow-conducting means specifically during operation. This can be achieved by adjusting mechanisms known per se (see below) or by interchangeable elements on the active flow-conducting means, for example, the propeller blades.

The at least one active flow-conducting means is mechanically connected, directly or indirectly, to the shaft rotating in the operating state in order to obtain the active flow line through the one or more means, the specific energy input on the shaft being directed to the main propeller and the further means for active flow guidance.

In particular, the active flow-conducting means is arranged directly on the shaft of the main propeller and is mechanically connected to it in such a way that the means can be directly driven by the shaft. The mechanical connection is preferably rigid.

Alternatively, the drive is effected by means of transmissions known as such, such as planetary transmissions and/or coaxial multi-part shafts.

In one embodiment of the invention, the specific energy input for the flow-conducting effect of the means is controllable, in particular by variability of the angle of attack of the agitator blade of a propeller-shaped means and/or by variability of the ratio of the mechanical transmission of the drive of the means, in particular in connection with embodiments with planetary gear units and/or coaxial multi-part stirrer shafts.

Alternatively, the active flow-conducting means have a separate shaft with completely separate mechanics, so that the energy input can thus be controlled separately.

The active flow-conducting means surprisingly causes a collapse of otherwise undesirable turbulent flows on the propeller shaft. It produces a purpose-directed downward flow in the vicinity of the propeller shaft without significantly more mechanical work and thus higher specific energy being required than would be the case, for example, by a second main propeller on the shaft dimensioned similarly to the first main propeller. It is found that, in particular, by means of small-dimensioned and actively propagated structures along the propeller shaft, such as short propeller vanes or by intermittent conveyor screws, a highly efficient flow line can be achieved at the shaft and consequently a stable toroidal flow of the solution and suspension through the vessel. The pumping action of the main propeller and thus the efficiency of the entire process, in particular the evaporation crystallization, is improved with little additional mechanical effort for driving the agitator. Above all, the dispersion of the formed crystal-containing suspension is improved. This leads to a reduction in the specific total energy input into the crystallizer with the same mixing quality or to an improvement in the mixing quality with an unchanged specific total energy input into the crystallizer.

The invention also relates to a stirred reactor, but particularly to a vacuum pan crystallizer, especially for discontinuous evaporation crystallization, which contains the improved stirrer described herein.

Finally, the invention also encompasses the teaching of the use of at least one active flow-conducting means, as characterized herein, on a shaft of a stirrer of a vacuum pan crystallizer to improve its blending performance. A particular application is in a vacuum pan for maintaining the mixing capacity of the stirrer during the discontinuous evaporation crystallization, even with varying levels of filling of the crystallizer vessel.

### DETAILED DESCRIPTION

The invention is described in more detail by means of the following FIGURE, without this being intended to be limiting.

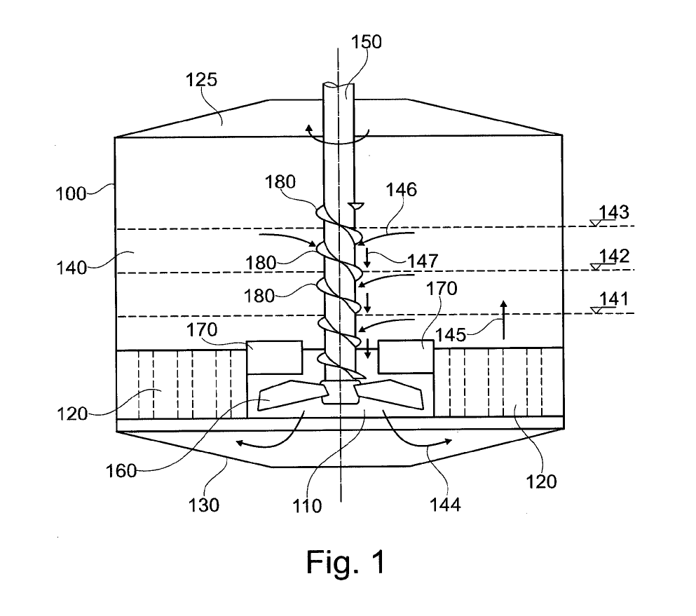

FIG. 1 shows a schematic representation of a common vertical vacuum pan with vertical reactor vessel 100. In the lower region, this contains solution or suspension 140, from which the crystal product is to be obtained. At the upper end, the vapor space 125 is provided with a steam extraction. Flow-through heating elements (heat exchanger) 120 are arranged in the lower region of the vessel. An agitator shaft 150 is suspended substantially vertically (perpendicularly) from the top in the vessel 100. In a primary mixing zone 110, here directly at the lower end of the shaft, there is arranged a main propeller, i.e, blade, 160, which, upon rotation of the drive shaft 150, moves the solution or suspension located in the vessel downwards and in a primary direction towards the vessel bottom. The downwardly directed flow 144 of the solution or suspension is directed into the heating chambers 120 by the bottom-side baffle 130 on the vessel 100. By virtue of active pumping and assisted by a reduction in the density by heating the solution or suspension in the heating chamber 120 as well as by the formation of steam bubbles, it leaves the heating chamber essentially in a vertically upward direction 145. The pumping action of the main propeller 160 is assisted by fixed baffle plates 170 arranged adjacent thereto. According to the invention, active flow-directing means 180 are provided along the drive shaft 150 above the main propeller 160 and, in the immediate vicinity of the drive shaft 150, provide an active flow 147 of the solution or suspension towards the main propeller 160 in the direction of the drive shaft. This effectively supports the effect of the stirrer. A stable circular flow 144, 145, 146, 147 is formed via the compensating flows 146. Depending on the fill level 141, 142 or 143 of the solution or suspension 140 in the reactor 100, more or fewer sections or units of the flow-conducting means 180 engage with the same. The specific total energy demand on the shaft 150 is thereby always adapted to the filling level 141, 142 or 143.

1. A stirrer for a vacuum pan, suitable for circulating a solution or suspension to be crystallized in a vessel, comprising a shaft,
a main propeller disposed in a primary mixing zone and connected to the shaft; and
at least one active flow-conducting means on the shaft and upstream of the main propeller for active flow guidance of the solution or suspension, the at least one active flow-conducting means is selected from a group consisting of:
1) a plurality of flow-conducting propellers each having a flow-conducting propeller diameter less than 50% of a main propeller diameter of the main propeller, the plurality of propellers arranged at a distance from each other along the shaft, and
2. a screw running along the shaft, having a screw that is a diameter at most 50% of the main propeller diameter.

2. The stirrer according to claim 1, wherein the at least one active flow-conducting means is arranged directly adjacent to the primary mixing zone.

3. The stirrer of claim 1 in combination with the vacuum pan.

4. The vacuum pan according to claim 3, wherein the vacuum pan is designed for discontinuous operation.

5. A method of using the active flow-conducting means of claim 1, on the shaft of the stirrer to improve a mixing capacity.

6. The method according to claim 5 for improving the mixing capacity of the stirrer in a vacuum pan in discontinuous operation.

7. The stirrer according to claim 1, wherein the at least one active flow-conducting means comprises the plurality of flow conducting propellers.

8. The stirrer according to claim 1, wherein the at least one active flow-conducting means comprises the screw.
